(19) United States
(12) Patent Application Publication
(10) Pub. No.: US 2008/0262926 A1
(43) Pub. Date: Oct. 23, 2008

(54) Business system and method to increase revenues in baseball and other sports

(75) Inventors: Jeffrey E. Spriegel, Kenmore, NY (US); Andrew R. Spriegel, Massillon, OH (US)

Correspondence Address: Andrew R. Spriegel, 8064 Clifton Court Circle NW, Massillon, OH, 44646, US

(73) Assignee: ANOVA INNOVATIONS, LLC

(21) Appl. No.: 12/081,853

(22) Filed: Apr. 21, 2008

Related U.S. Application Data
(60) Provisional application No. 60/925,309, filed on Apr. 19, 2007.

(51) Int. Cl. G06Q 30/00

(52) U.S. Cl. 705/14

(57) ABSTRACT

A business method of increasing fan attendance and sporting event revenues, the method comprising capturing in digital or analogue form a fan notable act, awarding points for the fan notable acts based upon specified factors, acknowledging the fan notable act with team or association recognition and/or prize(s), keeping statistics on the fan notable acts, and displaying and/or acknowledging the fan notable acts and/or statistics

### REFERENCE TO RELATED APPLICATION

This application claims priority to and the benefit of U.S. Provisional Application Ser. No. 60/925,309 which was filed Apr. 19, 2007, entitled BUSINESS METHOD PATENT TO INCREASE REVENUES IN BASEBALL, the entirety of which is hereby incorporated by reference as if fully set forth herein.

### BACKGROUND

Current attempts at increasing fan attendance, e.g., at baseball games and adding additional revenue throughout the entire 182 game season has not been entirely successful when a team is losing or has been eliminated from playoff contention. Marketing agencies have provided an expensive number of promotions, giveaways, and contests to get fans actively involved in the games and to increase attendance and participation. This is also true for other sporting events, for example, football, soccer, basketball and the like.

Accordingly, there is a need for systems and methods to improve attendance, increase merchandise sales, and to increase revenue from concession stands throughout the season and especially late in the season of amateur and professional teams, such as baseball, who have fallen out of playoff contention late in the season.

### SUMMARY OF THE INVENTION

This invention provides a unique opportunity to allow the fan to participate in sporting events, offers team self-promotion and provide a needed boost to sports. Although the invention will be described in detail with respect to baseball, to increase fan interest in “America's national pastime” it applies equally well to other sports. Imagine the fan and community interest in a daily, weekly, monthly, and yearly contest such as the “Fan Catch of the Week.” This can increase baseball enthusiasm worldwide.

Few sports have the opportunity to revitalize themselves like baseball based upon fans catching baseballs in the stands. According to USA Today, when you ask young people what they want, “the answer is clear and resounding: They want to be rich and famous.” Baseball has the unique opportunity to give fans what they want. In an age when there are more and more sporting events to compete for fan attention, attendance at games and team merchandise revenue, baseball can increase fan interest and dedication by implementing, for example, “Fan Catch of the Week”.

Why not recognize and give fans what many desperately want, their fifteen minutes of fame or a “lottery type” monetary reward? Why do fans show up at the Progressive Field, shout and hold up signs and continually look up to see if they are on the electronic scoreboard. Why does “Joe Fan,” from Philadelphia, have a plane fly overhead with a banner asking his wife if she would marry him, at a Philadelphia Phillies Game? Joe invited his friends and family to the game, he videotaped or had videotaped the nightly news, tipped off the nightly news about his plans. Joe was looking to have a great time at the game but he was also looking for his 15 minutes of fame.

Baseballs answer to revitalizing itself once again and generating additional major revenue is foul balls, homers, etc., that wind up in the stands and are caught by fans. An every game occurrence can be transformed into a promotion that renews the interest of both dedicated fans and those perhaps now on the fringe of fan support.

A daily, weekly, monthly and yearly contest of the best fan catches at ball parks all across America will help revitalize interest in baseball, add significant untapped revenue, and provide a unique opportunity for the common man to get the attention and recognition they seek and deserve, however they rarely attain. Dozens of baseballs are hit into the stands at every game.

In accordance with an aspect of the invention, a business method of increasing fan attendance and sporting event revenues, the method comprising capturing in digital or analogue form a fan notable act, awarding points for the fan notable acts based upon specified factors, acknowledging the fan notable act with team or association recognition and/or prize(s), keeping statistics on the fan notable acts and displaying and/or acknowledging the fan notable acts and/or statistics.

Another aspect of the invention relates to a business method of increasing fan attendance and baseball revenues, the method comprising (a) positioning cameras and camera operators to electronically capture a given fan catch, (b) filming the given fan catching a foul ball or home run, (c) obtaining the given fan consent and determining the given fan's name and personal information, (d) photographing and/or videotaping the given fan and nearby fans, (e) recording the given fan catch and/or the given fan close-up onto electronic device after a team and/or MLB promotions or between promotions, (f) providing and/or selling the given fan catch to the given fan and nearby fans, (g) displaying the given fan catch on a score board w/the given fan's name and replays of the catch, (h) adding the given fan's catch to weekly catches from other teams, (i) determining top fan catches of the week for the teams and/or MLB and televises them, (j) entering fan catches of the week into collection of best catches of the year, (k) voting on top ten catches of the year by a committee and/or general public, (l) televising and acknowledging top ten catches of the year, (m) awarding one million dollar prize to number one catch of the year or monetary award to top ten catches and (n) adding top ten catches to fan catch hall of fame.

Yet another aspect of the invention relates to a business system for increasing fan attendance and sporting event revenues, the method comprising a central statistics and data (CSD), wherein the CSD comprises a summation of individual team fan awarded points and individual team fan statistics and is configured to transmit and receive digital and analogue media to a fan notable act display system (FNADS), wherein a FNADS is configured to display fan notable acts (FNA) in the fan notable act storage (FNAS), wherein the FNAS is configured to collect and process a team fans data (TFD) and the CSD stores, processes and displays team fans game statistics.

### BRIEF DESCRIPTION OF THE DRAWINGS

FIG. 1 illustrates a functional block diagram of a system that increases revenues in baseball and other sports according to an aspect of the present invention;

FIG. 2 illustrates a table as an exemplary approach for determining point totals for a system according to yet another aspect of the present invention;

FIG. 3 illustrates a flow chart of an exemplary business method that increases revenues in baseball and other sports according to an aspect of the present invention;

FIG. 4 illustrates a flow chart of another exemplary business method that increases revenues in baseball and other sports according to an aspect of the present invention; and

FIG. 5 illustrates yet another flow chart of an exemplary business method that increases revenues in baseball and other sports according to an aspect of the present invention.

### DETAILED DESCRIPTION

Professional and amateur sporting teams are constantly looking for new approaches to add to the number of team fans, increase sporting event attendance, boost merchandise sales and the like. Fans, for the most part, enjoy be recognized at these events, as evidenced by drawing attention to themselves, e.g., painting their bodies with team colors, wearing outlandish costumes, holding up signs and other attention seeking behavior. This is often done to get them recorded on camera. This can be seen when a camera “sweeps” a crowd in a stadium and the people recognize that they are being broadcast on the “big screen” and jump up and down and wave.

This invention gives the fans their “fifteen minutes of fame” by documenting, recording, televising, either in analogue, digitally or electronically, some notable act. Although this event will describe fans catching baseballs in the stands as the notable act, this should not be read to limit the invention. The notable acts comprise fan holding signs, fans wearing costumes, fans dancing, young fans, old fans, fans wearing team merchandise, fans that are season ticket holders, disabled fans, new fans, loyal fans and the like.

Baseball is an extremely popular sport and in addition to the spectacular catches and plays made on the field by players, fans have made spectacular catches in the stands. This invention allows fan catches to be seen, for example, on television as part of local news broadcasts, national sports news, “This Week in Baseball”, on ESPN, and on the big screens and “Jumbotrons” at Major League ballparks along with maintaining statistics on fan catches. This could increase nightly news coverage as well as fans tuning in to see themselves or friends on TV and to see statistics on how the team fans are doing in relation to other team fans in catching foul balls and home runs. For example, videos and electronic recorded medium of fan catches, their picture on the scoreboard, the crowd erupting in applause could be sold to generate an additional revenue streams. As another example show four great plays made by the baseball team players, then a fan catch and then additional catches made by team members, packaged as a video, CD, DVD, flash drive or other electronic storages device. The fan could request the players that he likes and the fan's catch could buried in the video, DVD, etc., with the fan catch on their own personal DVD. This makes the fan feel like a real part of the team.

A yearly competition could be held between all major league teams with the top fan catches shown at an end of year fan catch award shows. Statistics based upon points could be kept for each team based upon specified factors. As an example, the team is awarded one point if the baseball is caught with a mitt and two points if the baseball is caught barehanded. Additional points could be awarded based upon additional factors, for example, if the fan is wearing team apparel that is worth an additional point, if the fan is wearing opposing team's apparel the opposing team is awarded one hundred points. This would encourage people coming into a city from other cities not only increasing the revenue for the team but also for the city.

These types of competitions will increase fan attendance, interest, and enthusiasm for the game, especially as the season comes to a close. Highlight shows, MLB, ESPN, award shows, video games, and local ballparks would likely be excited to participate. More fan interest would result in higher local and national television ratings, greater attendance, more website visits and the like. With media exposure and ratings being a key component of generating income for teams and the media outlets, this is the perfect opportunity for teams and the media to increase revenues from attendance, retail sales, advertising and MLB and team websites. Higher attendance will result at major league ballparks. Attendance tends to drop off late in the season when the team will not be going to the playoffs, however if the team is doing well with respect to fan catches or if monetary awards are offered this would drive higher attendance levels. Fans will attend the games hoping to be recognized or anticipating or wanting to win a prize. More fans could potentially tune in to watch news broadcasts to see what fans made a catch and/or what prizes they were awarded. Higher television ratings for local and national news could again generate higher revenues from those ratings. The fan catches could be shown on the MLB website and people could call a toll number in order to vote on their favorite catches, for example. Fans checking back on MLB.com could significantly increase web site and advertising hits.

This invention offers advantages for increased revenue for owners, media outlets and cities. Greater fan attendance, both locally and from other cities would translate into revenue for the city, the team and the local economy. Greater interest in attending games would boost local morale, advertising dollars and television revenue.

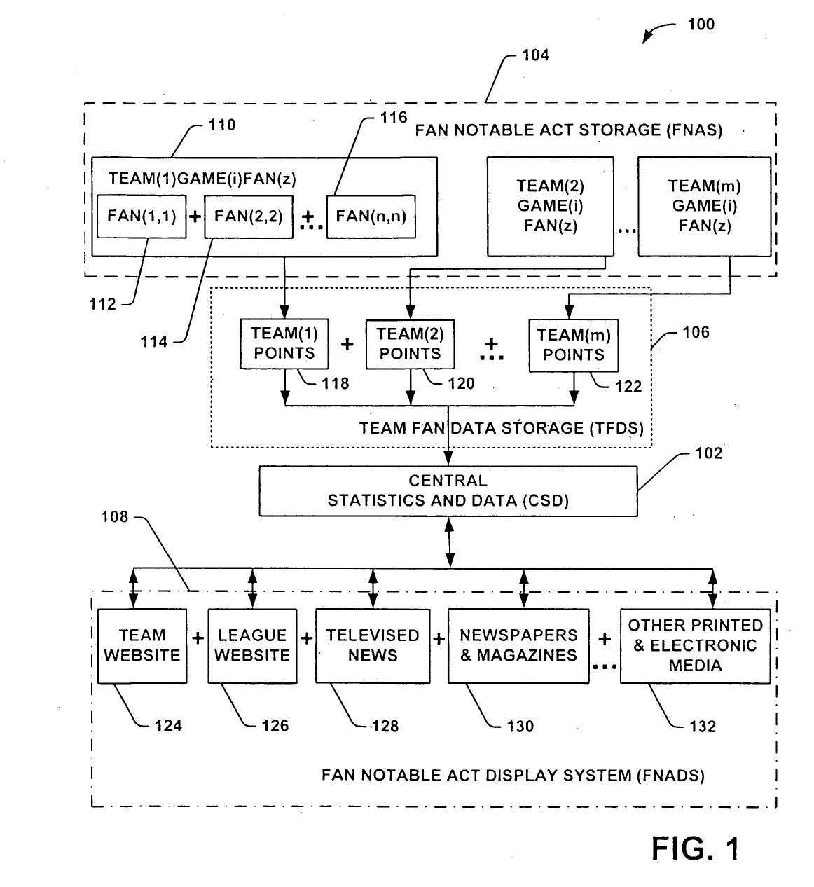

Turning now to the figures, FIG. 1 illustrates a system 100 (FIG. 1) that increases revenues in baseball and other sports comprising central statistics and data (CSD) 102, fan notable act storage (FNAS) 104, a team fan data storage (TFDS) 106 and a fan notable act display system (FNADS) 108. The CSD 102 comprises statistics and data regarding fan notable acts. Even though the invention is specifically described with respect to baseball fan catches of foul balls or home runs, notable acts can also comprise fans wearing costumes, fans holding signs, long term season ticket fans, and the like. The notable acts can be given a score based upon factors. Those factors comprise catching a ball bare handed, catching a ball in a mitt, wearing official home team merchandise when catching a ball, wearing official opposing team merchandise when catching a ball, stand section where a ball was caught, a fan catching a ball is a season ticket holder, the difficulty of the catch, and the like.

The fan notable act storage (FNAS) 104 comprises team fan game statistics 110 which includes all of the participating teams from team(1), team(2), team(3) . . . to team(n), wherein n is the number of participating teams. The minimum number of teams can be one. For example, the total number of fan points obtained in the first game for team(1) is represented by “team(1)game(i)fans(z)” 110, wherein “team(1)” represents the first participating team, for example, the Cleveland Indians, “game(i)” represents the i^{th} game, for example the first game of the season and “fan(z)” is the number of fans catching a ball in the stands. Referring to statistics 110, fan(1,1) 112 represents a first point total, wherein the first point total is for a first fan in the first game to make the first catch, fan(2,2) 114 represents a second point total, wherein the second point total is for a second fan in the first game that made a second catch, fan(n,n) 116 represents a n^{th} point total, wherein the n^{th} point total is for a n^{th} fan in the first game that made a n^{th} catch.

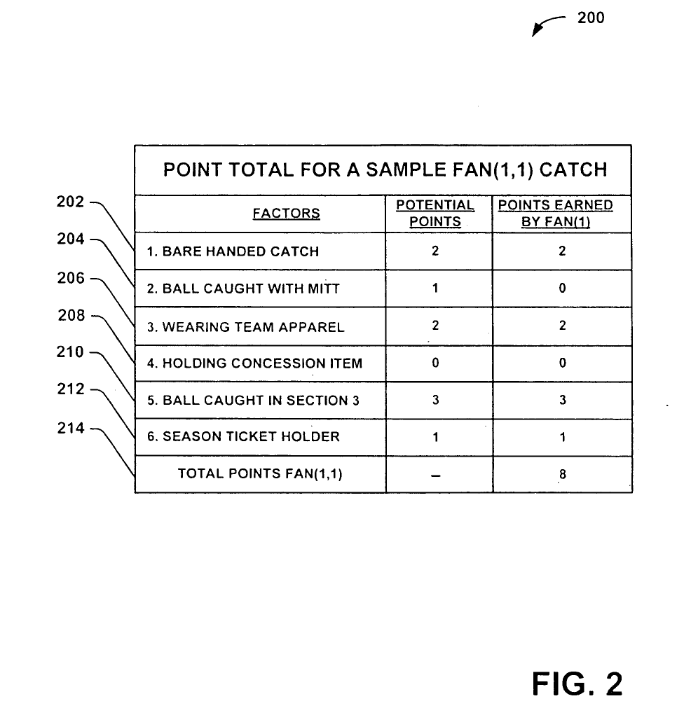

Referring to FIGS. 1 and 2 illustrated is an exemplary approach for determining point totals for fan(1,1) are calculated based upon factors, for example. According to FIG. 2, a point totaling system 200 comprises factors, e.g., factor(1) 202 is a given fan catching the ball bare handed; factor(2) 204 is the given fan catching the ball with a mitt; factor(3) 206 is the given fan wearing team apparel; factor(4) 208 is the given fan holding a concession item, factor(5) 210 is the given fan catching the ball in section 3 (e.g., a section that foul balls enter infrequently) and factor(6) 212 is the given fan is a season ticket holder. The total points awarded in this example is the summation of the points for factor(1) through factor(6). In this example, referring to FIG. 2, the fan(1,1) caught the ball bare handed (2 points), was wearing a team apparel (2 points), caught the ball in section 3 (3 points), is a season ticket holder (1 point) for a total points fan(1,1) 216 of eight points. In this example, eight points for fan(1,1) are added to team(1) points.

The approach mentioned supra can be repeated for fan(2,2) 114 through all of the fans that caught a ball to fan(n,n) 116, wherein n is the maximum number of catches made in game 1. This process can also be repeated for the remaining teams from team(2) through team(m), wherein m is the maximum number of teams. The eight points of fan(1,1) 112 are added to team(1) points 118 along with any other points from other fans that were made in game 1, for example. The team 1 points 118, and team(2) points 129 through team(m) points 122 are collected in the CSADS 102 after each game and can be posted on a team website 124, a MLB website 126, televised news 128, newspapers and magazines 130 and other printed and electronic media 132 by way of the fan notable act display system.

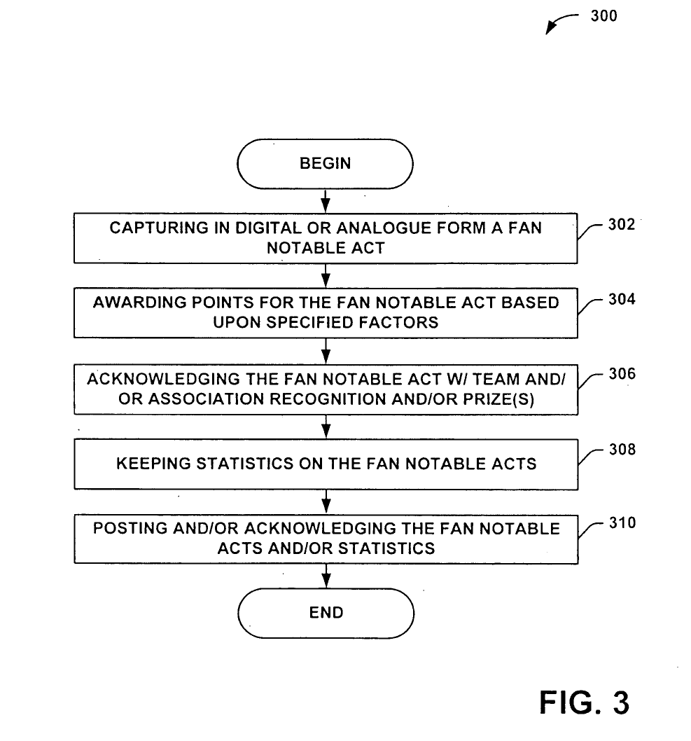

FIG. 3 illustrates yet an exemplary business method 300 for increasing revenues in baseball, media associations, websites, and other sporting events. The method begins at 302, a fan performing a notable act at a sporting event is captured in analog or digital form (e.g., on televised cameras, on video tape, photographed, etc.). Notable acts of the fan comprise catching a ball in the stands, painting their face and/or chest, wearing team merchandise, creating a sign to display during a contest or event, shaving their heads, coloring their hair, wearing costumes or uniforms to gain attention and resorting to personal antics (e.g., dancing) to be noted at games or events. At 304, the notable act is awarded points based on specific factors related to a notable act. Points may be awarded for concurrent factors at the time of the notable act performed by the fan.

At 306, an entity comprising a team, association, league, and group can acknowledge the fan with an award comprising personal recognition, merchandise, and monetary prize. Associations compromise any sport including but not limited to Major League baseball, the NFL, the NBA, NASCAR, the WNBA, major league soccer, college lacrosse, college basketball, college football, the NCAA, the Big 10 and any other major sports organization. The personal recognition comprises scored points and/or statistics being shown on the display screen at the sporting event, receiving merchandise, obtaining a monetary reward and earning recognition, for example, having the fan's name, hometown and the notable act displayed on the display screen at the game. The sporting event can be either amateur or professional and comprises baseball, soccer, lacrosse, basketball, football, rugby and cricket.

At 308, the team, association, entity, organization, or group keeps statistics on fan notable acts. Any record keeping, point tabulation or displaying of statistics is contemplated in this embodiment. Competition involving fan notable acts can be broken down, for example, by categories comprising team, city, venue and individual. At 310, a group comprising, the team, the association, and the entity acknowledges statistics and/or fan notable acts. The notable acts can be ranked, compared, and ordered based on the desirability, uniqueness, or interest generated by viewing of the event. At 312, the team, association, entity or group maintains scoring with other teams, associations, entities or groups, wherein the method ends.

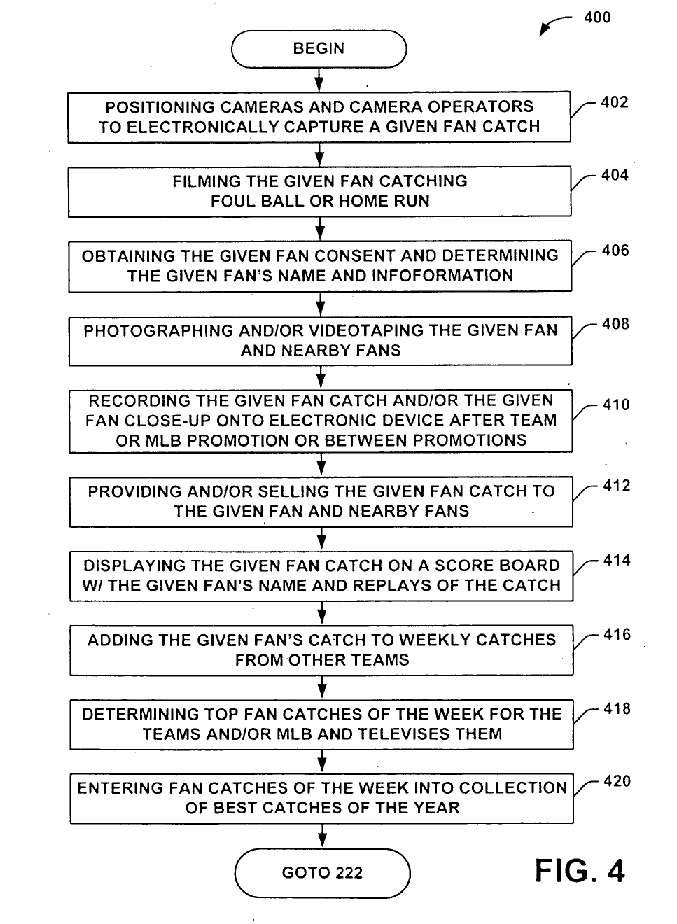

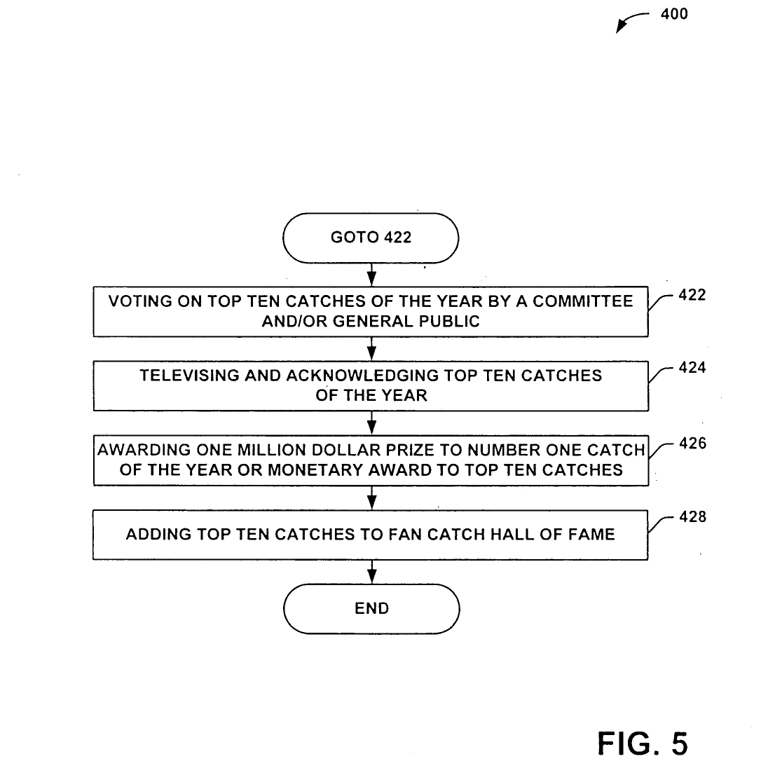

Turning now to the FIGS. 4 and 5 shown is one exemplary business method 400 for increasing revenues in baseball and other sports. At 402, cameras and camera operators are positioned, for example, to film fan catches. This may involve additional cameras and camera operators and/or repositioning of the cameras to capture the fan catches either in either analogue or digital form. At 404 a fan catches a foul ball or a home run that is recorded by a camera operator. The entity, team or association would have to define a “legitimate” catch comprising, for example, a catch that does not hit the stands, a catch that is not touched by another spectator, a catch that does not hit the ground, and the like.

At 406, if it is determined that a legitimate catch is made by a given fan then, for example, assigned team personnel can obtain information and/or writings comprising the given fan's signature on a fan consent form, the given fan's name, home town, age, and at 408 take pictures of the given fan and surrounding fans and/or video tape the given fan and surrounding fans, and the like. At 410, the given fan catch and/or the given fan close-up are recorded onto blank or pre-recorded media after a team and/or MLB promotion or between promotions. The pre-recorded media device comprises a flash drive, a CD, a DVD, and the like, with optionally the team and/or MLB logo on the outside of the media device. At 412, the devices can either be sold or given away, e.g., to the given fan, the surrounding fans, family members, other fans, etc. T-shirts printed with “FAN CATCH OF THE WEEK” can be printed along with a picture of the fan catching the ball printed on the shirt. While several prizes have been discussed in this invention this invention is in no way limiting the prizes that the fan can receive, however one of the primary focuses of the prize is to recognize the fans and give them the recognition they desire.

The method continues at 414, wherein the given fan's catch is shown on a score board with the given fan's name, hometown and replays of the given fan's catch, for example. The given fan's catch at 416 is added to weekly catches from teams all over the country similar to the way it is for players. At 418, a committee, for example determines top fan catches of the week for teams and/or MLB and televises them. In this way the fans can not only connect with the players on the field but also the fans that perform a notable act, thereby increasing enthusiasm for the team. For example, a team or MLB can reward a number the fans with the three best catches, for example, during a given month with monetary awards. For example, the 1^{st}, 2^{nd} and 3^{rd} fans get $100,000, $50,000 and $25,000 respectively. Greater rewards or points can be awarded for catches during the playoffs or World Series. The top catches for the month can be televised.

At 420, best fan catches of the week can be entered into a collection of best fan catches of the year. This invention is not limited to “fan catch of the week”, the invention can comprises “fan catch of the day”, “fan catch of the month”, “fan costume of the month”, “best fan dance of the month”, and the like. The method 400 continues in FIG. 5, at 422, wherein a top ten catches of the year list is voted on by a committee and general public. The voting by the general public can, for example, can comprise toll calls, further adding to team, entity and association revenues. A portion of this money, for example, could be donated to charity, used for city projects, etc., further enhancing the image of the team, entity and associations.

At 424, the team, entity and/or association could televise and acknowledge top ten catches of the year. The acknowledgement comprises posting the fans on a website, creating baseball cards with fans pictures on them and the like. A fan with the best fan catch of the year at 426, can be awarded a one million dollar prize or a monetary award can be made to top ten catches of the year. It should be appreciated that the award can be any awarded to recognize fan that are known by those of skill in the art. At 428, the top ten fan catches can be added to a fan hall of fame. The fan hall of fame can comprise any fans deemed worthy of being placed in the fan hall of fame based upon team, entity and/or association criteria. The method 400 ends after 428.

What is claimed is:

1. A business method of increasing fan attendance and sporting event revenues, the method comprising:
capturing in digital or analogue form a fan notable act;
awarding points for the fan notable acts based upon specified factors;
acknowledging the fan notable act with team or association recognition and/or prize(s);
keeping statistics on the fan notable acts; and
displaying and/or acknowledging the fan notable acts and/or statistics.

2. The method of claim 1, wherein the fan notable acts comprise at least one of the following: catching a baseball, dancing in the stands, painting a portion of their body, holding a sign, beating a drum and leading a cheer.

3. The method of claim 1, wherein the number of awarded points for the fan notable act is based upon specified factors, wherein the specified factors comprise at least one of the following: the number of baseball catches made by a fan, the fan is wearing team clothing apparel when making the catch, the fan is from out of town, the baseball catch is made bare handed, the baseball catch is made with a glove, the location in the crowd where the fan catches the baseball, the fan is holding a concession stand item when making the baseball catch, the fan is wearing a visiting team apparel when making the baseball catch, the fan is a season ticket holder, the length of time the fan is a season ticket holder, the fan is holding a sign that is judged to be awarded points, the fan has painted a portion of their body with team colors, and fan is dancing in a way that is judged to be awarded points.

4. The method of claim 1, wherein the awarded points are added up for each participating team and are utilized for a team notable acts playoff and a team notable acts championship.

5. The method of claim 1, wherein the awarded points are displayed as statistics comprising: data broken down into categories, the notable acts, searchable text, searchable information, searchable by name, capable of sorting, the statistics posted on an electronic media and the statistics posted in print.

6. The method of claim 1, wherein the fan that made the fan notable act receives recognition and/or prize(s) comprising at least one of the following: a monetary award, a baseball catch posted on a website, a pre-recorded media device with the fan notable act recorded on the device, a shirt with the fan notable act printed on the shirt, game tickets, their name and photo posted on a scoreboard, team apparel, autographed team apparel and a listing of their name and picture in a fan hall of fame.

7. The method of claim 1, wherein the digital or analogue form comprises at least one of the following: a television signal, digital TV, an audio signal, video cassette, photographs, digital photographs, printed media, and conventional magnetic analog storage media.

8. The method of claim 1, wherein the sporting event is either amateur or professional and comprises baseball, soccer, lacrosse, basketball, football, rugby and cricket.

9. A business method of increasing fan attendance and baseball revenues, the method comprising:
(a) positioning cameras and camera operators to electronically capture a given fan catch;
(b) filming the given fan catching a foul ball or home run;
(c) obtaining the given fan consent and determining the given fan's name and personal information;
(d) photographing and/or videotaping the given fan and nearby fans;
(e) recording the given fan catch and/or the given fan close-up onto electronic device after a team and/or MLB promotions or between promotions;
(f) providing and/or selling the given fan catch to the given fan and nearby fans;
(g) displaying the given fan catch on a score board w/the given fan's name and replays of the catch;
(h) adding the given fan's catch to weekly catches from other teams;
(i) determining top fan catches of the week for the teams and/or MLB and televises them;
(j) entering fan catches of the week into collection of best catches of the year;
(k) voting on top ten catches of the year by a committee and/or general public;
(l) televising and acknowledging top ten catches of the year;
(m) awarding one million dollar prize to number one catch of the year or monetary award to top ten catches; and
(n) adding top ten catches to fan catch hall of fame.

10. The method of claim 9, wherein the catch is a legitimate catch wherein the team or the MLB would define the legitimate catch as comprising, a catch that does not hit the stands before being caught, a catch that is not touched by another spectators before being caught and a catch that does not hit the ground before being caught.

11. The method of claim 9, wherein the team and/or MLB promotions comprise at least one of the following: the given fans favorite players making great plays, music, MLB highlights, other fan catches and photographs of the given fan with their favorite player.

12. A business system for increasing fan attendance and sporting event revenues, the method comprising:
a central statistics and data (CSD), wherein the CSD comprises a summation of individual team fan awarded points and individual team fan statistics and is configured to transmit and receive digital and analogue media to a fan notable act display system (FNADS);
wherein a FNADS is configured to display fan notable acts (FNA) in the fan notable act storage (FNAS);
wherein the FNAS is configured to collect and process a team fans data (TFD); and the CSD stores, processes and displays team fans game statistics.

13. The method of claim 12, wherein the fan notable acts comprise at least one of the following: catching a baseball, dancing in the stands, painting a portion of their body, holding a sign, beating a drum and leading a cheer.

14. The system of claim 12, wherein the number of the awarded points for the fan notable act is based upon specified factors, wherein the specified factors comprise at least one of the following: the number of baseball catches made by a fan, the fan is wearing team clothing apparel when making the catch, the fan is from out of town, the baseball catch is made bare handed, the baseball catch is made with a glove, the location in the crowd where the fan catches the baseball, the fan is holding a concession stand item when making the baseball catch, the fan is wearing a visiting team apparel when making the baseball catch, the fan is a season ticket holder, the length of time the fan is a season ticket holder, the fan is holding a sign that is judged to be awarded points, the fan has painted a portion of their body with team colors, and fan is dancing in a way that is judged to be awarded points.

15. The system of claim 12, wherein the awarded points are added up for each participating team and are utilized for a team notable acts playoff and a team notable acts championship.

16. The system of claim 12, wherein the awarded points are displayed as statistics stored in the CSD comprising: data broken down into categories, the notable acts, searchable text, searchable information, searchable by name, capable of sorting, the statistics posted on an electronic media and the statistics posted in print.

17. The system of claim 12, wherein the fan that made the fan notable act receives recognition and/or prize(s) comprising at least one of the following: a monetary award, a baseball catch posted on a website, a pre-recorded media device with the fan notable act recorded on the device, a shirt with the fan notable act printed on the shirt, game tickets, their name and photo posted on a scoreboard, team apparel, autographed team apparel and a listing of their name and picture in a fan hall of fame.

18. The system of claim 12, wherein the digital or analogue form comprises at least one of the following: a television signal, digital TV, an audio signal, video cassette, photographs, digital photographs, printed media, and conventional magnetic analog storage media.

19. The method of claim 1, wherein the sporting event is either amateur or professional and comprises baseball, soccer, lacrosse, basketball, football, rugby and cricket.
